(19) United States
(12) Patent Application Publication
(10) Pub. No.: US 2014/0278453 A1
(43) Pub. Date: Sep. 18, 2014

(54) Medical Treatment Management

(71) Applicant: Comprehensive Outcomes Management Technologies, LLC, Aurora, CO (US)

(72) Inventors: Scott J. Primack, Greenwood Village, CO (US); Tashof Bernton, Littleton, CO (US)

(21) Appl. No.: 13/800,537

(22) Filed: Mar. 13, 2013

(51) Int. Cl. G06F 19/00

(52) U.S. Cl. CPC G06F 19/345
USPC 705/2

(57) ABSTRACT

A medical treatment management system disclosed herein collects psychological data for a patient and a sequence of functional data about the functional status of the patient. The system generates a modified patient profile, such as a biopsychosocial profile, using the sequence of functional data and the psychological data. Subsequently, the modified patient profile is compared with a normative patient profile to generate a patient treatment regimen that may be prescribed for the patient.

### FIELD

Implementations disclosed herein relate, in general, to healthcare management technology and specifically to technology for managing medical treatment.

### BACKGROUND

Medical sciences and technologies have made tremendous progress over recent decades. As a result, medical professionals have a large number of new technologies available for treating their patients. However, despite the advances in the medical sciences and technologies, there has been insufficient quantitative assessment of functional outcomes.

### SUMMARY

A medical treatment management system disclosed herein collects psychological data of a patient and a sequence of functional data about the functional status of the patient. The system generates a modified patient profile, such as a biopsychosocial profile, using the sequence of functional data and the psychological data. Subsequently, the modified patient profile is compared with a normative patient profile to generate a patient treatment regimen that may be prescribed for the patient.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

A further understanding of the nature and advantages of the present technology may be realized by reference to the figures, which are described in the remaining portion of the specification.

FIG. 1 illustrates an example block diagram representing a medical treatment management system disclosed herein.

FIG. 2 illustrates an alternative example block diagram representing a medical treatment management system disclosed herein.

FIG. 3 illustrates an example flowchart for generating a patient treatment regimen using the medical treatment management system disclosed herein.

FIG. 4 illustrates an example flowchart for generating an insurance authorization matrix using the medical treatment management system disclosed herein.

FIG. 5 illustrates an example block diagram illustrating generating a treatment regimen using the medical treatment management system disclosed herein.

FIG. 6 illustrates an example computing system that can be used to implement the medical treatment management system disclosed herein.

### DETAILED DESCRIPTION

With the advances in medical sciences and technologies, medical professionals have a large amount of new information and tools available for patient treatment. However, there has been insufficient data available to quantify the functional status of the patient over time. By collecting and properly evaluating such data, medical decision makers can provide more cost effective and more clinically effective medical care.

Furthermore, existing medical treatment systems do not make effective use of patient psychological data in combination with the patient's functional status over time. For example, a patient showing the symptoms of psychosomatization may be provided a different medical treatment compared to other patients not showing symptoms of psychosomatization. By integrating a sequence of patient functional data with the patient's psychological data, the described system provides an objective technique for better evaluating and adjusting a patient's treatment.

Accordingly, a medical treatment management system disclosed herein provides a better methodology for treatment of patients using their functional status in combination with their psychological status. The medical treatment system disclosed herein integrates collected patient functional data over time with data about a patient's psychological status to determine the course of treatment for the patient. For example, in an implementation of an example medical treatment management system, psychological and functional data related to a patient is charted and compared to normative data (also referred to as “norms”) before determining or adjusting the course of treatment. In one implementation, the charting of the psychological and functional data includes generating a modified patient profile, such as a biopsychosocial profile, of the patient. The biopsychosocial model of health is based in part on social cognitive theory. The biopsychosocial model implies that treatment of disease processes, for example type two diabetes and cancer, requires that the health care team address biological, psychological and social influences upon a patient's functioning. In a philosophical sense, the biopsychosocial model states that the workings of the body can affect the mind, and the workings of the mind can affect the body. This means both a direct interaction between mind and body as well as indirect effects through intermediate factors.

The normative data may include, for example, data of a patient population with demographic, functional, and/or psychological characteristics similar to that of the patient for whom the medical treatment regimen is being developed. Furthermore, after a round of treatment, the patient is provided feedback in view of the charting completed before the treatment was initiated.

Yet an alternative implementation of the medical treatment system disclosed herein integrates the psychological and dynamic functional data for the patient to determine the course of medical treatment for the patient. For example, a sequence of functional data including the patient's physical characteristics and diagnostic data is used together with the psychological data about the patient to generate the modified patient profile. Such a modified patient profile is further compared to a normative patient profile to determine the patient treatment regimen. An implementation of the medical treatment system disclosed herein provides for electronic storage of the functional data sequences, the psychological data, and the normative data and for automated processing of such data to generate or adjust the patient treatment regimen.

Yet another alternative implementation of the medical treatment management system disclosed herein also provides for evaluating efficacies of various patient treatments that are generated based on the patient treatment regimen. In one implementation, the efficacy in measured in terms of the cost effectiveness of the treatment. Alternatively, the efficacy may be measured in terms of the patient satisfaction. In other alternatives, other measures of efficacy, such as number of return visits for the patient, medical professionals' time, etc., may also be used. Combinations of such metrics may also be employed.

FIG. 1 discloses a medical treatment management system 100 for generating patient treatment regimen based on various information related to a patient 102. For example, the patient 102 may be a patient with complains about knee joint pain. Such knee join pain may be result of an injury, muscular degeneration, arthritis, infection, bone tumors, etc. The medical treatment management system 100 illustrates a medical professional 104, such as a physical therapist that interacts with the patient 102 to generate treatment plan for the patient 102. The medical practitioner 104 may be affiliated with a service provider 106, such as a hospital, a wellness clinic, an independent practice, etc. Each of the patient 102, the medical practitioner 104, and the service provider 106 may also interact with an insurance provider 108, such as a health management organization (HMO), etc.

The medical treatment management system 100 illustrates that various patient data 110 is collected from the patient 102. Such patient data 110 may include, for example, sequential functional data about the patient's condition, psychological data of the patient, demographic data of the patient, medical history of the patient, etc. In case of the patient 102 with the knee pain, the functional data may include, the level of pain, the amount of difficulty in bending the leg with the knee pain, swelling of the knee, etc. In one implementation, functional data for a patient suffering from knee related medical condition is generated using a functional status questionnaire provided in Table 1.

TABLE I

| | |
|---|---|
| | Re- |
| | sponse |
| Question | (Y/N) |

Does your knee allow you to sleep?
Will your knee straighten fully?
Will your knee bend all the way?
Is your knee free from swelling?
Does your knee move smoothly without catching or locking?
Can you sit comfortably with your knee bent for one hour?
Can you enter and leave a car without difficulty?
Can you stand and walk without your knee giving away?
Does your knee allow you to walk two blocks without difficulty?
Does your knew allow you to do usual work?
Does your knee allow you to go downstairs easily?
Does your knee allow you to run?
Does your knee allow you to fully participate in a sport?
Does your knee allow you to kneel comfortably?
Can you hop on one leg?

While in the illustrated functional status questionnaire, the responses from the patient are expected in the form of yes or no, in an alternative implementation, such responses may be provided based on a scale, such as on a scale of one to ten, with one being indication of extremely bad functional status and ten being an indication of an extremely good functional status. In one implementation, the responses from the patient to the functional status questionnaire may be quantified into a composite functional status indication number. For example, when the functional status questionnaire allows for responses on a scale of one to ten, such a composite functional status indication number may be generated by the sum of the responses to the individual questions. Yet alternatively, each question may be given different weight in generating such a functional status indication number. Alternative patient response metrics may also be employed.

The psychological data about the patient 102 may include the patient's depression level, the level of substance abuse for the patient, etc. Such psychological data may be collected based on interviews with the patient, providing questionnaires to the patient, based on available past reports, IQ scores, observation data, etc. While the implementation 100 illustrates such patient data 110 coming from the patient 102, in an alternative implementation, such data may also be collected from the medical practitioner 104, the service provider 106, the insurance provider 110, and other sources.

The medical treatment management system 100 also illustrates that various normative data 120 is also collected from sources, such as the service provider 106, the insurance provider 108, data available from government resources such as the Center for Disease Control (CDC), etc. In the example case where the patient 102 has a complaint of knee pain, such normative data 120 may be related to other patients with similar complaints or symptoms. Furthermore, the normative data 120 may also be generated from population that is representative of the patient 102 in terms of age, gender, ethnic background, etc. The normative data 120 may also include functional data for the patient population such as, for example, the level of functional difficulty experienced by patients in the patient population, the symptoms, the recovery period, etc. In one implementation, the normative data of the patient population is converted into a normative patient profile. For example, such a normative patient profile may be a single composite value, a data structure including various values, etc.

The medical treatment management system 100 uses the patient data 110 and the normative data 120 to generate treatment regimen 130 for the patient 102. Specifically, the medical treatment management system 100 uses the patient data 110 to generate a modified patient profile, such as a biopsychosocial profile of the patient. For example, the sequence of functional data about the patient is integrated with the psychological data to generate the biopsychosocial profile of the patient. The medical treatment management system 100 uses the normative data 120 to generate the normative patient profile. Thus, in the case of the patient 102 with knee pain, the normative data 120 provides the level of improvement for other patients having similar age, weight, etc. In that case, such normative data is used to generate the normative patient profile. Subsequently, the modified patient profile is compared with the normative patient profile to generate or adjust a treatment regimen 130 for the patient.

In one implementation, the treatment regimen 130 is generated using a computer system that processes the patient data 110 and the normative data 120. For example, such processing may include modifying the patient's functional data with the patient's psychological data. In the case of the patient 102 with knee pain, the level of pain as noted by the patient 102 may be modified based on the depression level of the patient. Thus, if the patient 102 is depressed, then the level of knee pain indicated by the patient 102 may be more psychosomatic. In such a case, it is likely that, even if a treatment plan alleviates the swelling of the knee and therefore the cause of the pain, the patient 102 may still continue to indicate higher pain levels in their functional data response.

Furthermore, the medical treatment management system 100 also generates a patient communication plan using the patient treatment regimen 130. For example, normative data may be communicated by the medical professional 104 to the patient 102 before and during the treatment of the patient 102. Subsequently, the medical provider 104 informs the patient 102 that given the patient's age, weight, and arthritic symptoms, the patient 102 should not expect to see complete alleviation of knee pain. Such communication with the patient 102 improves the patient satisfaction at the end of the treatment plans. Furthermore, it also removes the necessity for continued unnecessary treatment, when based on the comparison to the normative data it is clear that the incremental improvement resulting from such treatment is minimal.

The treatment regimen 130 may generate a prescribed treatment 132 that is used by the medical professional 104 to provide treatment to the patient 102. For example, in the case of the patient 102 with knee pain that is diagnosed as resulting from an arthritic knee joint, the prescribed treatment 132 may include prescription for appropriate anti-inflammatory pain medications (e.g., NSAIDS), cortisone injections, etc. Furthermore, the prescribed treatment 132 may also include a physical therapy program for the patient 102, a diet and exercise recommendation for the patient 102, etc. Yet alternatively, the prescribed treatment 132 may also include the communication guidelines that may be used by the medical practitioner 104 to communicate with the patient 102. For example, such communication guideline may include the expected improvement for the patient, one or more charts, tables, etc., illustrating the improvement for normative patient population, the timeline illustrating when the improvement is expected to plateau, etc.

An implementation of the medical treatment management system 100 also generates an insurance authorization matrix 134 based on the treatment regimen 130. Such an insurance authorization matrix 134 may include information about the recommended patient treatment, the normative data about other patients with similar conditions, etc. In one example, the insurance authorization matrix 134 may also provide the expected cost of administering the treatment as per the prescribed treatment 132 to the patient 102, the savings resulting from such prescribed treatment 132 being compared to the costs related to providing treatment to patients from normative population (as permitted by law), etc. In yet another alternative implementation, the insurance authorization matrix 134 may also include other information such as patient satisfaction levels resulting from the treatment, the recidivism rates for patients receiving the prescribed treatment compared to alternative treatment plans, etc. Providing such an insurance authorization matrix 134 to the insurance provider 108 improves the likelihood that the insurance company will provide prompt payment to the service provider 106

FIG. 2 illustrates an alternative example block diagram representing a medical treatment management system 200. Specifically, the medical treatment management system 200 generates various decision matrices for a patient 202. The medical treatment management system 200 includes collection of various patient data 210 that may be collected from the patient 202, a medical practitioner working with the patient 202, a service provider such as a hospital, an insurance provider, etc. The patient data 210 may be stored in the memory of a computing device such as a desktop, a laptop, a data server, etc.

In the example implementation, the patient data 210 includes temporally-sequenced functional data 212 about the patient 202. Such functional data may include, for example, the symptoms related to the patient's illness or complaint, answers to various functional status questionnaires, etc. The psychological data 214 about the patient 202 may include information about the patient's general happiness, depression levels, IQ scores, readings for the Zung depression levels for the patient, etc. The diagnostic data 216 includes the results of the patient diagnosis. Thus, for a patient that is diagnosed with high blood pressure, such diagnostic data 216 may include the actual levels of diastolic and systolic blood pressure, etc.

The patient data 210 also includes demographic data 218 about the patient, such as the patient's income, race, ethnicity, etc. In one implementation, the demographic data 218 may be used to select normative data that is used to generate a normative patient profile or a benchmark patient profile. The insurance data 220 may include the insurance information, the level of insurance coverage for the patient 202, the network of service providers available to the patient 202, etc. In alternative implementations, the patient data 210 also includes other information, such as a patient's education, work history, etc.

The various patient data 210 may be used to generate a patient profile 230. In one implementation, the patient profile 230 includes a functional profile 232 and a psychological profile 234. Each of the functional profile 232 and the psychological profile 234 may be in the form of a data structure containing information about the patient 202. For example, the functional profile 232 may include a data structure containing scores/values of the patient's functional status. Such functional status may be generated using a functional status questionnaire, from results of functional test conducted for the patient, etc. Alternatively, the functional profile 232 may be structured as a sequence of observations over time.

Similarly, the psychological profile 234 may also include a data structure that provides scores/values for various fields. For example, one field of such a profile may be the anxiety level of the patient 202; the other field may be the Zung depression score for the patient 202, etc. In one implementation of the medical treatment management system 200, a modified patient profile 236 is generated by integrating one or more values from the functional profile 232 with one or more values from the psychological profile 234. For example, if the functional profile 232 has a field that provides the score representing the level of difficulty in using stairs, the modified patient profile 236 adjusts such score based on the level of depression. Subsequently, the score for such normalized or modified level of difficulty may be used to compare the patient condition with a normative patient profile and to generate various decision matrices.

The medical treatment management system 200 also includes normative data 240 that may be stored in a data structure form. The normative data 240 includes demographic norms 242, insurance norms 244, and diagnostic norms 246. Each of the norms 242, 244, 246 may be generated based on queries to a database of population data 248. For example, various fields in the functional profile 232 or in the modified patient profile 236 may be used in the queries to the population data 248 to generate the norms 242, 244, 246. In one implementation, the demographic norms 242 provide information about patients with demographic information similar to the demographic profile of the patient 202. The insurance norms 244 may provide information about prescribed treatments and payments for patients having a patient profile similar to the functional profile 232. However, in an alternative implementation, the insurance norms 244 may provide information about prescribed treatments and payments for patients having a patient profile similar to the modified patient profile 234.

The medical treatment management system 200 processes the information from the normative data 240 and the patient profile 230 to generate a decision matrix 250. In one implementation, the decision matrix 250 includes a patient treatment regimen 252 and an insurance authorization matrix 254. The patient treatment regimen 252 may be used to determine a prescribed treatment for the patient 202. In one implementation, the patient treatment regimen 252 is also used in generating a communication plan that can be used by a medical practitioner to communicate the prescribed treatment to the patient 202. For example, such a communication plan can be used to set patient expectations for the prescribed treatment administered to patient 202. The insurance authorization matrix 254 includes various information that may be submitted to an insurance provider to get approval of the medical treatment plan and/or to receive reimbursement for the costs associated with the treatment.

It should also be understood that one or more fields of the patient's psychological data may be independently integrated with one or more fields of the patient's functional data, with or without weighting, prior to generation of the functional and psychological profiles. In this manner, this pre-integration may be made at a more specific level prior to the generation of the respective functional and psychological profiles.

FIG. 3 illustrates an example flowchart 300 for generating a patient treatment regimen using the medical treatment management system disclosed herein. One or more operations of the flowchart 300 may be implemented using a computer processor or a plurality of computer processors communicatively connected to each other. A collecting operation 302 collects various patient data, such as functional data, psychological data, diagnostic data, demographic data, insurance data, etc. Such patient data may be collected using a computerized questionnaire that allows a patient, a medical practitioner, etc., to provide such information. Furthermore, some of the patient data may also be received by querying an insurance database, a service provider database, etc. The collection operation 302 may also include pre-integration of one or more specific fields of the patient's functional data and the patient's psychological data.

A generating operation 304 generates a patient profile using the patient data. Such patient profile may include a functional profile for the patient and a psychological profile for the patient. Furthermore, the information from the psychological profile may be used to generate a modified patient profile using another generating operation 306. Yet another generating operation 308 generates a normative patient profile using various normative data for the patient. For example the generating operation 308 may use various patient data in a query to a population database to generate such normative data. Thus, for example, if the patient with a given ethnic background has a knee problem, the generating operation 308 may query population database for other patients with similar conditions, demographics, etc.

A comparing operation 310 compares the patient profile or the modified patient profile to the normative data. While FIG. 3 illustrates the comparing operation 310 as being performed only once, in practice such comparing may be dynamic and performed over time. Thus, for example, initially the comparing may be performed to generate a prescribed treatment, however, after the treatment is initiated such comparing may be performed to determine the progress for the patient. As an example, as the patient is administered a prescribed treatment, various functional, psychological, and diagnostic data for the patient may change, causing reevaluation of the patient profile, psychological profile, regenerating of the normative patient profile, etc.

A determining operation 312 processes the normative data and the patient profile to determine a treatment regimen including a treatment plan for the patient. For example, for a diabetic patient, the treatment plan may include regimen of prescription drug combined with administration of insulin to the patient. As per a providing operation 314, a medical practitioner provides the treatment to the patient.

The efficacy of the treatment may be determined at the end of the treatment or at various stages throughout the treatment. For example, an evaluating operation 316 evaluates the cost effectiveness of the treatment and another evaluating operation 318 evaluates the patient satisfaction. The outputs from the evaluation operations 316 and 318 are used by an updating operation 320 to update the treatment regimen.

FIG. 4 illustrates an example flowchart 400 for generating an insurance authorization matrix using the medical treatment management system disclosed herein. One or more operations of the flowchart 400 may be implemented using a computer processor or a plurality of computer processors communicatively connected to each other. Various operations of the process illustrated by flowchart 400 are similar to such operations illustrated in flowchart 300 and therefore are not discussed here. Specifically, while the operations of flowchart 300 relate to generating a treatment plan, the operations of the flowchart 400 relate to generating an insurance authorization. Specifically, a determining operation 412 uses the normative data and the patient profile to generate an insurance authorization matrix for a treatment plan and a receiving operation 412 receives an authorization from the insurance company for providing the treatment.

In one implementation, the insurance authorization generation is a dynamic process with various operations being performed again over time based on new information and the patient treatment progress. For example, an updating operation 420 updates the insurance authorization matrix based on cost effectiveness, patient satisfaction, the progress of the treatment, changes in the patient data, etc.

FIG. 5 illustrates an example block diagram 500 illustrating generating a treatment regimen using the medical treatment management system disclosed herein. As illustrated, the functional data 502 and/or trend about a patient are stored in a data structure. Similarly, the psychological data 504 about the patient is stored in another data structure. While the illustrated implementation discloses the psychological data 504 as static, in an alternative implementation, the psychological data 504 may also be collected over time, thus providing a trend of patient psychological data. Various feedback loops may also be employed in the medical treatment management system.

The functional data 502 is integrated with the psychological data 504 at an integrating operation 506. For example, such integrating operation 506 may involve normalizing the functional data 502 using the psychological data 504, although other integration functions may be employed including without limitation various weighting schemes, statistical modeling, curve fitting. The modifying operation 506 generates a modified patient profile 508. The modified patient profile is compared with normative patient profile 510 at a comparing operation 512. The outcome of the comparison operation 512 is used to generate a patient treatment regimen 514. In an alternative implementation, the outcome of the comparing operation may also be used to generate an insurance authorization matrix, a patient communication plan, etc.

FIG. 6 illustrates an example computing system that can be used to implement one or more components of the medical treatment management system method and system described herein. A general-purpose computer system 600 is capable of executing a computer program product to execute a computer process. Data and program files may be input to the computer system 600, which reads the files and executes the programs therein. Some of the elements of a general-purpose computer system 600 are shown in FIG. 6, wherein a processor 602 is shown having an input/output (I/O) section 604, a Central Processing Unit (CPU) 606, and a memory section 608. There may be one or more processors 602, such that the processor 602 of the computer system 600 comprises a single central-processing unit 606, or a plurality of processing units, commonly referred to as a parallel processing environment. The computer system 600 may be a conventional computer, a distributed computer, or any other type of computer such as one or more external computers made available via a cloud computing architecture. The described technology is optionally implemented in software devices loaded in memory 608, stored on a configured DVD/CD-ROM 610 or storage unit 612, and/or communicated via a wired or wireless network link 614 on a carrier signal, thereby transforming the computer system 600 in FIG. 6 to a special purpose machine for implementing the described operations.

The I/O section 604 is connected to one or more user-interface devices (e.g., a keyboard 616 and a display unit 618), a disk storage unit 612, and a disk drive unit 620. Generally, in contemporary systems, the disk drive unit 620 is a DVD/CD-ROM drive unit capable of reading the DVD/CD-ROM medium 610, which typically contains programs and data 622. Computer program products containing mechanisms to effectuate the systems and methods in accordance with the described technology may reside in the memory section 604, on a disk storage unit 612, or on the DVD/CD-ROM medium 610 of such a system 600, or external storage devices made available via a cloud computing architecture with such computer program products including one or more database management products, web server products, application server products and/or other additional software components. Alternatively, a disk drive unit 620 may be replaced or supplemented by a floppy drive unit, a tape drive unit, or other storage medium drive unit. The network adapter 624 is capable of connecting the computer system to a network via the network link 614, through which the computer system can receive instructions and data embodied in a carrier wave. Examples of such systems include Intel and PowerPC systems offered by Apple Computer, Inc., personal computers offered by Dell Corporation and by other manufacturers of Intel-compatible personal computers, AMD-based computing systems and other systems running a Windows-based, UNIX-based, or other operating system. It should be understood that computing systems may also embody devices such as Personal Digital Assistants (PDAs), mobile phones, smart-phones, gaming consoles, set top boxes, tablets or slates (e.g., iPads), etc.

When used in a LAN-networking environment, the computer system 600 is connected (by wired connection or wirelessly) to a local network through the network interface or adapter 624, which is one type of communications device. When used in a WAN-networking environment, the computer system 600 typically includes a modem, a network adapter, or any other type of communications device for establishing communications over the wide area network. In a networked environment, program modules depicted relative to the computer system 600 or portions thereof, may be stored in a remote memory storage device. It is appreciated that the network connections shown are for example and other means of and communications devices for establishing a communications link between the computers may be used.

Further, the plurality of internal and external databases, data stores, source database, and/or data cache on the cloud server are stored as memory 608 or other storage systems, such as disk storage unit 612 or DVD/CD-ROM medium 610 and/or other external storage device made available and accessed via a cloud computing architecture. Still further, some or all of the operations for the system for a medical treatment management system disclosed herein may be performed by the processor 602. In addition, one or more functionalities of the medical treatment management system disclosed herein may be generated by the processor 602 and a user may interact with these GUIs using one or more user-interface devices (e.g., a keyboard 616 and a display unit 618) with some of the data in use directly coming from third party websites and other online sources and data stores via methods including but not limited to web services calls and interfaces without explicit user input.

In the interest of clarity, not all of the routine functions of the implementations described herein are shown and described. It will, of course, be appreciated that in the development of any such actual implementation, numerous implementation-specific decisions must be made in order to achieve the developer's specific goals, such as compliance with application- and business-related constraints, and that those specific goals will vary from one implementation to another and from one developer to another.

According to one embodiment of the present invention, the components, process steps, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes and/or data structures may be implemented using machine language, assembler, C or C++, Java and/or other high level language programs running on a data processing computer such as a personal computer, workstation computer, mainframe computer, or high performance server running an OS, such as Windows® 7, and Windows® 8, available from Microsoft Corporation of Redmond, Wash., Apple® OS X-based systems and iOS-based system, available from Apple Inc. of Cupertino, Calif., or various versions of the Unix operating system, such as Linux, available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present technology, the term “data store” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, SQL databases, audit trails and logs, program memory, cache and buffers, and the like.

The above specification, examples and data provide a complete description of the structure and use of example embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understand that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method, comprising:
collecting psychological data for a patient and a sequence of functional data about functional status of the patient;
generating a modified patient profile using the sequence of functional data and the psychological data; and
generating a patient treatment regimen based on comparing the modified patient profile with a normative patient profile.

2. The method of claim 1 further comprising providing the patient treatment regimen to a medical service provider.

3. The method of claim 1 further comprising adjusting a prescribed treatment of the patient based on the patient treatment regimen.

4. The method of claim 1 further comprising generating a patient communication plan based on the patient treatment regimen.

5. The method of claim 1 further comprising generating an insurance authorization matrix based on the patient treatment regimen.

6. The method of claim 5 wherein generating the insurance authorization matrix further comprising generating the insurance authorization matrix with estimated cost for patient treatment and comparative costs for normative patient population.

7. The method of claim 1 further comprising generating the normative patient profile based on normative patient population.

8. The method of claim 7, wherein the normative patient population is based on at least one of (1) patient population having functional profile similar to a functional profile of the patient, (2) patient population having psychological profile similar to a psychological profile of the patient, and (3) patient population having demographic profile similar to a demographic profile of the patient.

9. The method of claim 1, further comprising:
evaluating cost effectiveness of treating the patient using the patient treatment regimen; and
updating the patient treatment regimen based on the cost effectiveness.

10. The method of claim 1, further comprising:
evaluating patient satisfaction as a result of treating the patient using the patient treatment regimen; and
updating the patient treatment regimen based on the patient satisfaction.

11. A system, comprising:
a computer readable memory module configured to store sequence of functional data about a patient's functional status, psychological data about the patient's psychological status, and normative data related to the patient;
a modification module configured to generate a modified patient profile using the sequence of functional data and the psychological data; and
a determination module configured to generate a patient treatment regimen based on comparing the modified patient profile with a normative patient profile.

12. The system of claim 11, wherein the determination module is further configured to generate an insurance authorization matrix based on the patient treatment regimen.

13. The system of claim 11, wherein the determination module is further configured to generate a patient communication plan based on the patient treatment regimen.

14. The system of claim 11, wherein the system further comprising a normative patient profile generation module configured to query a patient population database using the patient demographic data to generate the normative patient profile based on at least one of (1) patient population having functional profile similar to a functional profile of the patient, (2) patient population having psychological profile similar to a psychological profile of the patient, and (3) patient population having demographic profile similar to a demographic profile of the patient.

15. The system of claim 11, further comprising an evaluation module configured to generate a medical treatment evaluation based on at least one of (1) patient satisfaction and (2) cost effectiveness of the medical treatment regimen.

16. The system of claim 15, further comprising a feedback module configured to update the patient treatment regimen based on the medical treatment plan evaluation.

17. One or more tangible computer-readable storage media storing computer executable instructions for performing a computer process on a computing system, the computer process comprising:
collecting psychological data for a patient and a sequence of functional data about functional status of the patient;
generating a modified patient profile using the sequence of functional data and the psychological data;
generating a patient treatment regimen based on comparing the modified patient profile with a normative patient profile; and
providing the patient treatment regimen to a medical service provider.

18. The one or more tangible computer-readable storage media of claim 17, wherein the computer process further comprising generating a patient communication plan based on the patient treatment regimen.

19. The one or more tangible computer-readable storage media of claim 17, wherein the computer process further comprising generating an insurance authorization matrix based on the patient treatment regimen.

20. The one or more tangible computer-readable storage media of claim 17, wherein the computer process further comprising:
receiving cost data related to a treatment plan based on the patient treatment regimen;
receiving patient satisfaction data from a patient;
generating an evaluation matrix based on at least one of (1) the cost data; and (2) the patient satisfaction data.

21. The one or more tangible computer-readable storage media of claim 20, wherein the computer process further comprising adjusting the patient treatment regimen based on the evaluation matrix.
